(19) United States
(12) Patent Application Publication
(10) Pub. No.: US 2006/0105211 A1
(43) Pub. Date: May 18, 2006

(54) Fuel cell system

(76) Inventors: Myles L. Bos, Burnaby (CA); Shanna D. Knights, Burnaby (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/990,340

(22) Filed: Nov. 16, 2004

(51) Int. Cl. H01M 8/04; H01M 8/02

(52) U.S. Cl. 429/25; 429/38

(57) ABSTRACT

Membrane degradation in PEM fuel cells can be explained as follows. Hydrogen peroxide (H₂O₂) formed around cathodes and anodes catalytically reacts with Fenton's reagents to produce radicals. Such radicals attack the membrane and initiate oxidative decomposition. Only trace quantities of Fenton's reagent are necessary to lead to the production of radicals in-situ. Simply avoiding direct contact of Fenton's reagent elements with the MEA is therefore not sufficient to improve MEA lifetime. Components of a fuel cell system should also be made of materials that are essentially free of Fenton's reagents pursuant to the invention. One embodiment of the invention provides a fuel cell system, wherein the fuel cell stack and/or the supply apparatus and/or the discharge apparatus are/is made of materials that are essentially free of Iron (Fe).

### BACKGROUND OF THE INVENTION

1. Field of the Invention

The present invention relates to electrochemical fuel cell systems.

2. Description of the Related Art

Electrochemical fuel cells convert reactants, namely fuel and oxidant fluid streams, to generate electric power and reaction products. Electrochemical fuel cells employ an electrolyte disposed between two electrodes, namely a cathode and an anode. The electrodes each comprise an electrocatalyst disposed at the interface between the electrolyte and the electrodes to induce the desired electrochemical reactions. The location of the electrocatalyst generally defines the electrochemically active area.

Polymer electrolyte membrane (PEM) fuel cells generally employ a membrane electrode assembly (MEA) consisting of an ion-exchange membrane disposed between two electrode layers comprising porous, electrically conductive sheet material as fluid diffusion layers, such as carbon fiber paper or carbon cloth. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. The electrodes should be electrically insulated from each other to prevent short-circuiting. A typical commercial PEM is a sulfonated perfluorocarbon membrane sold by E.I. Du Pont de Nemours and Company under the trade designation NAFION®.

The MEA contains an electrocatalyst, typically comprising finely comminuted platinum particles disposed in a layer at each membrane/electrode layer interface, to induce the desired electrochemical reaction. The electrodes are electrically coupled to provide a path for conducting electrons between the electrodes through an external load.

In a fuel cell stack, the MEA is typically interposed between two separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein are commonly known as flow field plates. In a fuel cell stack, a plurality of fuel cells are connected together, typically in series, to increase the overall output power of the assembly. In such an arrangement, one side of a given plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air. In a fuel cell stack, reactant streams are typically supplied and exhausted by respective supply and exhaust manifolds. Manifold ports are provided to fluidly connect the manifolds to the flow field area and electrodes. Manifolds and corresponding ports may also be provided for circulating a coolant fluid through interior passages within the stack to absorb heat generated by the exothermic fuel cell reactions.

For a PEM fuel cell to be used commercially in either stationary or transportation applications, a sufficient lifetime is necessary. Such lifetime is typically linked to the lifetime of MEAs. There are significant difficulties in consistently obtaining sufficient lifetimes as many of the degradation mechanisms and effects on MEAs remain unknown.

It is known that high levels of iron contamination are a cause of MEA degradation, affecting both the ionomer and the catalyst. High levels of iron contamination are known to affect proton conductivity and catalyst activity, as well as, in the case of membrane humidifiers, to affect membrane capacity and reduce the humidification levels of the stack. This has resulted in efforts to eliminate any contact of metallic parts with the MEA and to remove metallic parts from the stack altogether. However, MEA degradation continues to be a problem in fuel cell stacks. Accordingly, there is a need in the art to understand the degradation process of MEAs and to develop design improvements to mitigate or eliminate such degradation.

The present invention fulfills the need to mitigate or eliminate degradation and provides further related advantages.

### BRIEF SUMMARY OF THE INVENTION

The invention provides a fuel cell system, wherein the fuel cell stack and/or the supply apparatus and/or the discharge apparatus are/is made of materials that are essentially free of Iron (Fe).

The invention further provides a fuel cell system, wherein the fuel cell stack and/or the supply apparatus and/or the discharge apparatus are/is made of materials that are essentially free from the group of materials consisting of Iron (Fe), Chromium (Cr), Titanium (Ti), Vanadium (V), Copper (Cu), Cobalt (Co) and Zinc (Zn).

The invention further provides a fuel cell system, wherein the fuel cell stack and/or the supply apparatus and/or the discharge apparatus are/is made of materials that are essentially free of Fenton's reagents. For example, the invention provides a fuel cell system, wherein the supply and discharge apparatus are made of materials selected from the group of materials consisting of Aluminum and plastics and/or the fuel cell stack is made of materials that are essentially free of Iron (Fe). In another example, the invention provides a fuel cell system wherein the supply and discharge piping, the oxidant and fuel pressure regulators and the humidification system are all made of materials selected from the group of materials consisting of Aluminum and plastics.

The invention also provides a fuel cell system, wherein the fuel cell stack and/or the portion of the fuel cell system upstream of the fuel cell stack/or the portion of the fuel cell system upstream of the fuel cell stack are made of materials that are essentially free of Iron (Fe).

The invention further provides a fuel cell system, wherein the fuel cell stack and/or the portion of the fuel cell system upstream of the fuel cell stack/or the portion of the fuel cell system upstream of the fuel cell stack are made of materials that are essentially free from the group of materials consisting of Iron (Fe), Chromium (Cr), Titanium (Ti), Vanadium (V), Copper (Cu), Cobalt (Co) and Zinc (Zn).

The invention further provides a fuel cell system, wherein the fuel cell stack and/or the portion of the fuel cell system upstream of the fuel cell stack/or the portion of the fuel cell system upstream of the fuel cell stack are made of materials that are essentially free of Fenton's reagents. For example, the whole fuel cell system, i.e. the fuel cell stack and the upstream and downstream portions of the fuel cell system, can be made of materials selected from the group of materials consisting of Aluminum and plastics.

These and other aspects of the invention will be evident upon reference to the attached figures and following detailed description.

### BRIEF DESCRIPTION OF THE DRAWINGS

FIG. 1 is a diagram of a Membrane Degradation hypothesis.

### DETAILED DESCRIPTION OF THE INVENTION

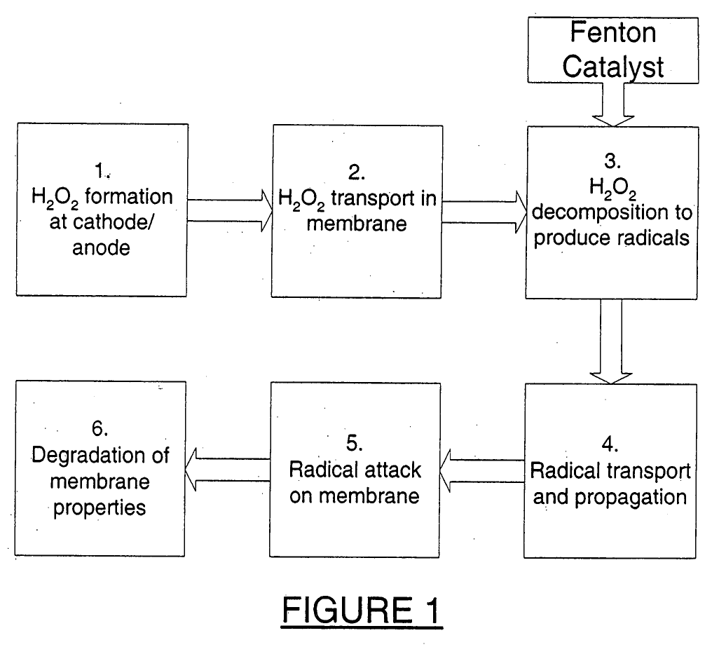

With reference to the simplified diagram in FIG. 1, MEA Degradation is believed to occur in six steps as follow:

1) Hydrogen Peroxide (H₂O₂) Formation

Hydrogen peroxide (H₂O₂) formation is thought to occur in a fuel cell as a result of reactant cross-over from one side of the membrane to the other or through incomplete oxygen reduction on the fuel cell cathode. Reactant cross-over can occur when oxygen crosses from the cathode to the anode or when hydrogen crosses from the anode to the cathode. Formation of H₂O₂ can occur via the reduction of oxygen, or from the oxidation of water, each of which depend on the chemical environment and the electrochemical conditions. Both water (H₂O) and H₂O₂ are formed during the first process.

2) H₂O₂ Transport & Accumulation

H₂O has a lower boiling point than H₂O₂, thereby tending to evaporate more quickly under drying conditions, leaving behind increased concentrations of H₂O₂. The H₂O₂ is then transported into the membrane by diffusion.

3) H₂O₂ Decomposition

Although H₂O₂ is generally very reactive, it is quite stable when free of impurities. In the presence of platinum, H₂O₂ decomposes without generating free radicals.

On the other hand, if the peroxide encounters a Fenton's reagent, such as iron (Fe), free radicals are produced (which may then take part in membrane degradation). Two reactions, involving iron that initiate hydroxyl & hydroperoxyl radicals, are primarily responsible for the initiation of the radical cycle.

In the first reaction, a ferrous ion (Fe⁺²) is oxidized to a ferric ion (Fe⁺³), with hydrogen peroxide (H₂O₂) being reduced to hydroxide (OH) and liberating a free hydroxyl radical (HO.). HO. is an extremely strong oxidizing agent, second only in strength to fluorine (F₂).

In the second reaction, a ferric ion (Fe⁺³) is reduced to a ferrous ion (Fe⁺²), thereby oxidizing the hydrogen peroxide (H₂O₂) into an acid (H⁺) and liberating a free hydroperoxyl radical (HOO.). HOO. is also a reactive radical, but is much more stable than HO., with the result that it is likely the dominant means for the radical mechanism to propagate.

4) Radical Transport & Propagation

For the Fenton's cycle to propagate, the initiated radical reacts with another non-radical species, where a single electron transfer or atom transfer occurs, thus quenching the initial radical and generating a new radical.

During the decomposition of H₂O₂ , one propagation reaction is where HO. reacts with more H₂O₂, oxidizing it to HOO. and itself being reduced to water.

Another propagation reaction is where the HOO. reacts with H₂O₂, liberating oxygen (O₂) and water as well as regenerating another HO., thereby further propagating the cycle.

The hydroxyl radical is believed to propagate by hopping from one water molecule to another, until it reacts with a species and terminates. This reaction is believed to be extremely fast (perhaps on the order of the rate of the acid dissociation of water i.e. k ˜10¹¹ L mol⁻¹ s⁻¹).

Among the other species that can react in the fuel cell environment, and further propagate the Fenton's cycle in an operating fuel cell, are hydrogen (H₂), water (H₂O) and oxygen (O₂). More specifically, the hydroxyl radical can react with hydrogen to generate a hydrogen radical (an oxidized form of hydrogen) and water. The hydrogen radical can also react with hydrogen peroxide to generate a hydroxyl radical and water. The hydrogen radical can also react with water to form a hydroxyl radical. Although very slow, this reaction likely propagates the cycle, especially considering the abundance of water in the system. Hydroperoxyl radicals can be generated from the reaction of hydrogen radicals with oxygen. This reaction can be very prominent in the fuel cell, especially in locations where the oxygen concentration is high.

Given that a Fenton's reagent is not necessary for many of the reactions that may propagate the Fenton's cycle, very little of a Fenton's reagent is necessary to initiate the cycle. This therefore outlines the necessity to significantly reduce if not eliminate sources of Fenton's reagents from the PEM fuel cell system. Particularly notable as Fenton's reagents are the following:

chromium (Cr)

cobalt (Co)

copper (Cu)

titanium (Ti)

vanadium (V)

iron (Fe)

zinc (Zn)

Although Iron (Fe) is the better known Fenton's reagents, it is relatively slower reacting than other common transition metal Fenton's reagents. The activities of each of these reagents also depend strongly on conditions of the reaction, such as temperature. This suggests that the activation energies of the different Fenton's reagents vary significantly as well.

For example, at room temperature, chromium(II) (Cr²⁺) is about 300 times more reactive than iron (II) (Fe⁺²), copper(I) (Cu⁺) is about 60 times more reactive than the iron (II) (Fe⁺²) and titanium(III) (Ti³⁺) is about 15 times more reactive than the iron(II). On the other hand, at 100° C., chromium(II) (Cr²⁺) is about 60 times more reactive than iron(II) (Fe⁺²), copper(I) (Cu⁺) is about 160 times more reactive than iron(II) (Fe⁺²) and titanium(III) (Ti³⁺) is about 15 times more reactive than iron(II) (Fe⁺²).

Alternatives to Fenton's reagents are numerous. For example, neither tin (Sn), nor Aluminum (Al) show any catalytic activity towards the decomposition of hydrogen peroxide. The same can be said for most types of plastics, such as PVC.

The radicals produced via the Fenton's cycle chemically attack the membrane (Step 5) and initiate oxidative decomposition, with the concomitant release of hydrogen fluoride (HF) and carbon dioxide (CO₂) (Step 6). The radicals produced can also attack other MEA components, such as the ionomer within the catalyst layer, and the carbon in the electrode. This can result in structural changes and/or changes to properties, such as hydrophobicity of electrode materials. These effects can further limit the durability of the fuel cell.

Eliminating iron from all components of a fuel cell system would therefore appear to result in extended MEA life. More broadly speaking, eliminating Fenton's reagents from all components of a fuel cell system would appear to result in extended MEA life. In this respect, eliminating Iron (Fe), Chromium (Cr), Titanium (Ti), Vanadium Monoxide (VO), Copper (Cu), Cobalt (Co) and Zinc (Zn) from all components of a fuel cell system would result in extended MEA life, but the invention should not be limited only to these specific Fenton's reagents.

Several components of a fuel cell system are targeted by this invention so as to yield MEA lifetime improvements. Pursuant to the invention, having the piping, transporting the oxidant and fuel streams to the fuel cell stack, free of Fenton's reagents is important. For example, such piping could be made of aluminum, plastic or other Fenton's reagent-free material. Removing Fenton's reagents from the piping downstream of the fuel cell stack is not initially as important, but becomes more so if the exhaust stream is not completely exhausted to the atmosphere, as is the case in systems that recirculate the exhaust stream or that uses the exhaust stream to supply the humidifier.

Pursuant to the invention, having the oxidant and fuel pressure regulators, for regulating the desired pressure of the oxidant and fuel streams to the fuel cell stack, free of Fenton's reagents is also important.

Such regulators can take many forms. For example, where the reactant stream originates from a source where gas pressure is higher than the desired pressure, the regulator can take the form of a variable opening valve system, which lets in as little or as much flow as necessary to maintain/attain the desired pressure: such regulators are typically called pressure regulators and are often present on the fuel supply side as hydrogen typically originates from a container in a high pressure state. In another example, where the reactant originates from a source where gas pressure is lower than the desired pressure, the regulator can take the form of a compressor: compressors are often present on the oxidant supply side as oxygen is typically drawn from the ambient environment. In yet another example, where the reactant originates from a source where gas pressure is substantially the same as the desired pressure, the regulator can take the form of a blower: blowers are also present on the oxidant supply side of fuel cell systems running at ambient pressures. In all cases, whether a pressure regulator, a compressor and/or a blower are used, these components are to be essentially free of Fenton's reagents. For example, they can be made of aluminum.

Pursuant to the invention, having the humidification system, for regulating the desired humidity of the oxidant stream and fuel stream to the fuel cell stack, free of Fenton's reagents is also important. For example, the humidifier can be made of plastic.

Having components of the fuel cell system, downstream of the fuel cell stack, free of Fenton's reagents is also important in cases where a portion of the exhaust stream is recirculated. In such cases, having the pipes, regulators and associated valves free of Fenton's reagents is important. For example, in fuel cell systems with cathode recirculation, having the recirculation piping, the recirculation blower and the jet ejector system free of Fenton's reagents would be important.

Even in cases where a portion of the exhaust stream is not recirculated, but is placed in contact with the inlet stream, having all related components of the fuel cell system, downstream of the fuel cell stack, free of Fenton's reagents would also be important. For example, in systems where the exhaust stream is used to supply the humidifier with water, having the related piping free of Fenton's reagents would be important.

Pursuant to the invention, not only is having the reactant streams free of Fenton's reagents is important, but also having the source of such reactant streams free of Fenton's reagents is important. For example, in systems where the hydrogen is generated for a fuel processing system, having all components of the fuel processing system free of Fenton's reagents would be important. In systems where the hydrogen is stored in containers, having such containers free of Fenton's reagents, for example made of aluminum or plastic as opposed to stainless steel, would be important.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

1-11. (canceled)

12. A fuel cell system comprising:
a fuel cell stack, and
supply piping to transport an oxidant stream and a fuel stream to the fuel cell stack,
an oxidant pressure regulator for regulating the desired pressure of the oxidant stream to the fuel cell stack,
a fuel pressure regulator for regulating the desired pressure of the fuel stream to the fuel cell stack, and
a humidification system for regulating the desired humidity of the oxidant stream and fuel stream to the fuel cell stack,
wherein the supply piping, the oxidant and fuel pressure regulators and the humidification system are made of materials that are essentially free of Iron (Fe).

13. The fuel cell system of claim 12, wherein the piping, the oxidant and fuel pressure regulators and the humidification system are made of materials that are essentially free from the group of materials consisting of Iron (Fe), Chromium (Cr), Titanium (Ti), Vanadium (V), Copper (Cu), Cobalt (Co) and Zinc (Zn).

14. The fuel cell system of claim 13, wherein the piping, the oxidant and fuel pressure regulators and the humidification system are made of materials that are essentially free of Fenton's reagents.

15. The fuel cell system of claim 14, wherein the piping, the oxidant and fuel pressure regulators and the humidification system are made of materials selected from the group of materials consisting of Aluminum and plastics.

16. The fuel cell system of claim 12, further comprising discharge piping to transport the oxidant stream and fuel stream away from the fuel cell stack, wherein the discharge piping is made of materials that are essentially free of Iron (Fe).

17. The fuel cell system of claim 13, further comprising discharge piping to transport the oxidant stream and fuel stream away from the fuel cell stack, wherein the discharge piping is made of materials that are essentially free from the group of materials consisting of Iron (Fe), Chromium (Cr), Titanium (Ti), Vanadium (V), Copper (Cu), Cobalt (Co) and Zinc (Zn).

18. The fuel cell system of claim 14, further comprising discharge piping to transport the oxidant stream and fuel stream away from the fuel cell stack, wherein the discharge piping is made of materials that are essentially free of Fenton's reagents.

19. The fuel cell system of claim 15, further comprising discharge piping to transport the oxidant stream and fuel stream away from the fuel cell stack, wherein the discharge piping is made of materials consisting of Aluminum and plastics.

20. The fuel cell system of claim 12, further comprising:
an oxidant supply source for supplying the oxidant stream, and
a fuel supply source for supplying the fuel stream
wherein the oxidant supply source and the fuel supply source are made of materials that are essentially free of Iron (Fe).

21. The fuel cell system of claim 13, further comprising:
an oxidant supply source for supplying the oxidant stream, and
a fuel supply source for supplying the fuel stream
wherein the oxidant supply source and the fuel supply source are made of materials that are essentially free from the group of materials consisting of Iron (Fe), Chromium (Cr), Titanium (Ti), Vanadium (V), Copper (Cu), Cobalt (Co) and Zinc (Zn).

22. The fuel cell system of claim 14, further comprising:
an oxidant supply source for supplying the oxidant stream, and
a fuel supply source for supplying the fuel stream
wherein the oxidant supply source and the fuel supply source are made of materials that are essentially free of Fenton's reagents.

23. The fuel cell system of claim 15, further comprising:
an oxidant supply source for supplying the oxidant stream, and
a fuel supply source for supplying the fuel stream
wherein the oxidant supply source and the fuel supply source are made of materials consisting of Aluminum and plastics.

24. The fuel cell system of claim 16, wherein the fuel cell stack is made of materials that are essentially free of Iron (Fe).

25. The fuel cell system of claim 20, wherein the fuel cell stack is made of materials that are essentially free of Iron (Fe).

26. The fuel cell system of claim 17, wherein the fuel cell stack is made of materials that are essentially free from the group of materials consisting of Iron (Fe), Chromium (Cr), Titanium (Ti), Vanadium (V), Copper (Cu), Cobalt (Co) and Zinc (Zn).

27. The fuel cell system of claim 21, wherein the fuel cell stack is made of materials that are essentially free from the group of materials consisting of Iron (Fe), Chromium (Cr), Titanium (Ti), Vanadium (V), Copper (Cu), Cobalt (Co) and Zinc (Zn).

28. The fuel cell system of claim 18, wherein the fuel cell stack is made of materials that are essentially free of Fenton's reagents.

29. The fuel cell system of claim 22, wherein the fuel cell stack is made of materials that are essentially free of Fenton's reagents.

30-37. (canceled)
